(19) United States
(12) Patent Application Publication
(10) Pub. No.: US 2025/0305576 A1
(43) Pub. Date: Oct. 2, 2025

(54) OILING SYSTEM FOR A CENTRIFUGAL SUPERCHARGER

(71) Applicant: Christopher Scott Spies, Belton, MO (US)

(72) Inventor: Christopher Scott Spies, Belton, MO (US)

(21) Appl. No.: 19/098,949

(22) Filed: Apr. 2, 2025

Related U.S. Application Data
(60) Provisional application No. 63/573,425, filed on Apr. 2, 2024.

(51) Int. Cl. F16H 57/04; F04D 29/046

(52) U.S. Cl. CPC F16H 57/0458; F04D 29/046; F16H 57/045; F05D 2220/40; F05D 2260/98

(57) ABSTRACT

A centrifugal supercharger includes a transmission case with an aperture therethrough proximal and parallel to its axis, the transmission case having a transmission cover affixed to its rear end and a compressor backplate affixed to its front end. The compressor backplate includes an oil passage radially located within the compressor backplate. The oil passage has an oil inlet opening near the outer edge of the compressor backplate and an oil jet near the compressor backplate bore to direct oil or other lubricating fluid under pressure upon internal bearings located within the transmission case.

### CROSS REFERENCE TO RELATED APPLICATIONS

This application claims the benefit of the prior-filed, co-pending provisional patent application, Ser. No. 63/573,425, filed Apr. 2, 2024, incorporated herein by reference.

### BACKGROUND OF THE INVENTION

### Field of the Invention

The present invention relates to automotive engine components and more particularly to an improved oiling system for a centrifugal supercharger with a gear type transmission and an internal oil reservoir, and more particularly further to a centrifugal supercharger transmission incorporating dedicated oil jet lubrication of the proximal and/or distal impeller shaft bearings located at the ends of the impeller shaft.

### Description of the Related Art

In the prior art, the oiling systems of centrifugal superchargers having an internal oil reservoir comprise shafts operating on three parallel axes, connected by a series of intermeshing gears provided on the shafts: The first is the input shaft, driven by use of a series of belts and pulleys or gears, in driving connection to an external power source, which, in typical automotive applications, is the crankshaft of the engine to which the supercharger is installed. The next shaft in the series is the impeller shaft, to which the compressor section is directly connected. The primary rotating components of the compressor are the impeller shaft, supported by a pair of bearings and at one end a cantilevered impeller. The third shaft is that of a rotatable element, a slinger gear, which is partially submerged in the oil reservoir. The submerged slinger gear “slings” oil ono the supercharger bearings, shafts, and gears. This slinger design differed from prior designs which relied upon the pressurized oil supply of the engine to which the supercharger was in driving engagement to feed oil to the bearings, shafts, and gears of the supercharger. While the “slinger” design offers various benefits by virtue of its isolation from the driving engine's oil supply, it relies on incidental contact of oil with the shaft bearings. While this does provide adequate oiling for most applications encountered in the prior art, the reliance upon incidental contact of oil generated by the slinger with ball bearing elements limits the maximum speed at which a supercharger is able to be reliably operated.

### SUMMARY OF THE INVENTION

The invention pertains to centrifugal compressors and more specifically centrifugal superchargers for automotive applications. The invention offers an improved method for lubrication of the impeller bearings, which are often the “weak link” in a centrifugal supercharger transmission. This is the result of an elevation of ball and race temperatures arising from an inadequate flow of oil to areas of greatest frictional contact.

While designs have been developed for use of the drivingly connected engine's oil supply, they typically employ either: 1) the injection of oil into the gear mesh and/or the space between the shaft bearings and/or bearing pockets, or 2) flooding/filling of the space between the bearing and the bearing pocket. To date, these designs have not made use of an oil jet, directed at specific, critical locations of the bearing, and having sufficient velocity to reach heated bearing surfaces. The turbulence and entrainment of air which results when ball bearings are operated at high speeds carries oil away from heated bearing surfaces prior to oil coming into contact with bearing metals and as such limits the effectiveness of the aforementioned lubricating systems. Further, to-date no prior art supercharger design having an internal reservoir makes use of a pressure feed system to provide oil jet lubrication of the distal or proximal impeller shaft bearings.

In accordance with certain embodiments of the invention, a centrifugal supercharger includes a transmission case having a compressor section and a transmission section. An impeller in the compressor section is mounted to a shaft that extends into the transmission section. The impeller shaft is in driven engagement with a power input shaft by intermeshing gears provided on the shafts. A portion of the transmission section, typically the transmission case, defines a fluid reservoir in which lubrication fluid, typically oil, is held. The intermeshing gears, as well as the bearing assemblies supporting the shafts, are located outside the fluid reservoir portion of the transmission section. A rotatable fluid-propelling element (slinger) partly submerged in the lubrication fluid contained within the reservoir portion ensures that sufficient but not excessive lubrication fluid is supplied to the intermeshing gears and the bearing assemblies. In addition to the rotatable fluid-propelling element, additional lubrication is delivered to critical areas of the proximate bearing of the impeller shaft by means of a jet integrated into the compressor backplate.

Embodiments of the present invention make use of a pressurized oil source that collects oil from the supercharger's internal reservoir and redirects a pressurized flow of oil through a passage, or series of passages machined into the supercharger's compressor backplate. Configured as such, the understood benefits of a centrifugal supercharger having an internal reservoir (with no introduction of heat or contaminants by external sources, or use of oils optimized for ball bearing applications rather than motor oils) are retained, while also overcoming the limitations imposed by the splash or mist type oiling systems. This is in particular due to the ability to inject a sufficient volume of oil into areas of the impeller shaft bearings not accessible by splash/mist type systems. This is accomplished by virtue of the location as well as the velocity of the oil jet, as both are necessary to realize the full benefit of oil jet lubrication of a ball bearing.

Certain embodiments of the present invention include a centrifugal supercharger having a gear type transmission, an internal oil reservoir and oil jet lubrication, and one or more oil jets positioned to provide oil jet lubrication of the distal and proximal impeller shaft bearings within the transmission. In other embodiments, the centrifugal supercharger includes oil jet lubrication of the one or more proximal impeller shaft bearings but more conventional splash/bath/mist lubrication of the remaining bearings. The internal oil reservoir is integrated into the transmission case and one or more oil jets are integrated into the compressor backplate in certain embodiments. The oil pump may be internal to the transmission and located within either the transmission back plate or cover, or provided external to the transmission.

In certain embodiments, a centrifugal supercharger may comprise a generally cylindrical transmission case with an aperture therethrough proximal and parallel to the axis of the transmission case. The transmission case has a front end and a rear end, each located at opposite ends of the generally cylindrical body of the case, a transmission cover affixed to the transmission case rear end, and a compressor backplate affixed to the transmission case front end. A distal bearing is mounted upon an impeller shaft and a proximal bearing is mounted upon the impeller shaft forward of the distal bearing. The distal bearing, proximal bearing and impeller shaft are mounted within the aperture of said transmission case. An internal oil reservoir, and one or more lubrication oil jets are integrated into either the transmission case and/or compressor backplate to lubricate the bearings.

In certain embodiments, an oil suction line is attached at one end to an oil suction aperture in the wall of the oil reservoir and at another end to an oil pump. An oil supply line is attached at one end to the oil pump and at another end to the oil inlet in the compressor backplate, whereby oil may be drawn and flow from the oil suction aperture to the pump and then from the pump to the oil inlet under pressure to eject from the oil jet onto the bearings.

Other advantages of the invention will become apparent from the following description taken in connection with the accompanying drawings, wherein is set forth by way of illustration and example several embodiments of the present invention.

### BRIEF DESCRIPTION OF THE DRAWINGS

FIG. 1 is a front, perspective, exploded view of a supercharger transmission.

FIG. 2 is a rear, perspective, exploded view of a supercharger transmission.

FIG. 3 is a side elevation of the compressor backplate.

FIG. 4 is a front elevation of a compressor backplate containing an oil jet.

FIG. 5 is a cross-sectional view of a section of the compressor backplate taken generally along line 5-5 in FIG. 4 and including an enlarged detail view C to better show the oil jet and oil passage.

FIG. 6 is a front perspective view of a compressor backplate containing an oil jet and including an enlarged detail view B to better show the oil jet and oil passage.

FIG. 7 is a front elevation of a supercharger including a compressor backplate containing an oil jet.

FIG. 8 is a cross-sectional view taken generally along line 8-8 in FIG. 7 of a supercharger including a compressor backplate containing an oil jet.

FIG. 9 is a rear, perspective, exploded view of a supercharger transmission.

### DETAILED DESCRIPTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

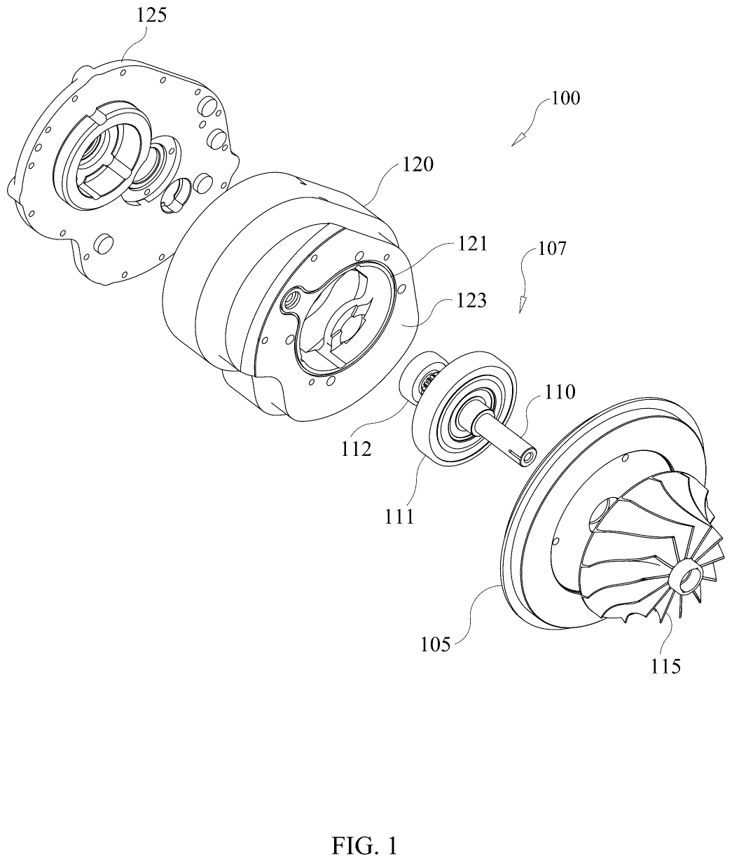

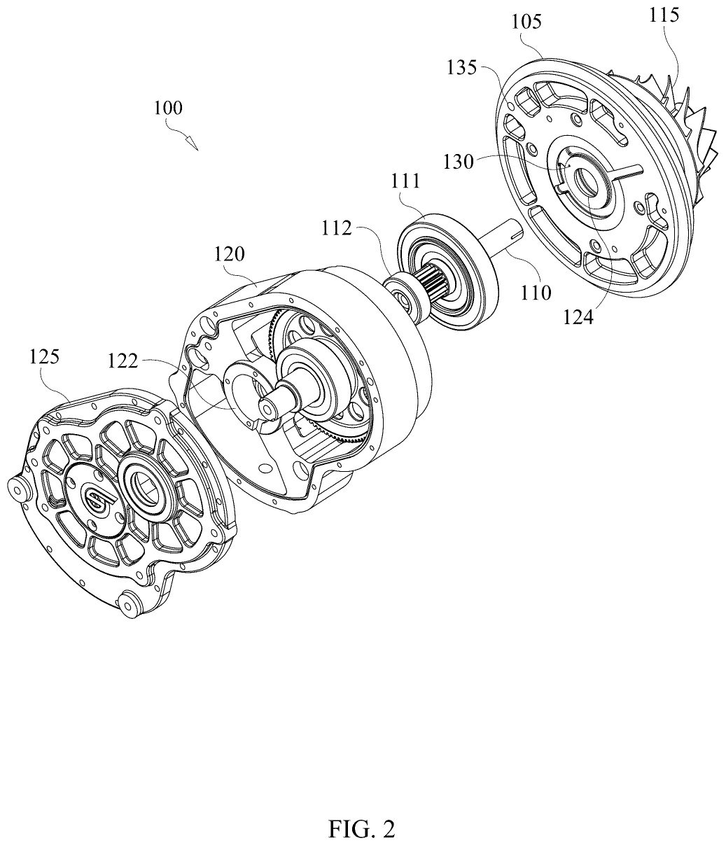

Referring now to the drawings, FIG. 1 illustrates a front, perspective, exploded view of a partial supercharger transmission assembly 100 of the present invention and FIG. 2 illustrates a rear, perspective, exploded view of the same. As shown, the supercharger transmission assembly 100 comprises a compressor backplate 105, an impeller shaft assembly 107, an impeller 115, a transmission case 120, and a transmission cover 125. When assembled, the compressor backplate 105 is seated against the forward face 123 of the transmission case 120 and the transmission cover 125 against the rear face of the transmission case 120. The assembled transmission case 120 and compressor backplate 105 form the axial and radial locating elements for the proximal bearing 111 located at the end of the impeller shaft 110 to which the impeller 115 is attached. When assembled, the proximal bearing 111 is housed within the large bore 121 in the face 123 of the transmission case 120. In a similar manner, the transmission cover 125 and the transmission case 120 provide a means for axially and radially locating the distal bearing 112 at the opposite end of the impeller shaft 110. The impeller shaft 110 is situated near a distal end within the impeller shaft bore 122 of the transmission case 120 and is situated at a proximal end within a compressor backplate bore 124 centrally located in a compressor backplate 105. The compressor backplate 105 is positioned between the impeller 115 and transmission case 120 and is attached to the forward face or surface 123 of the transmission case 120.

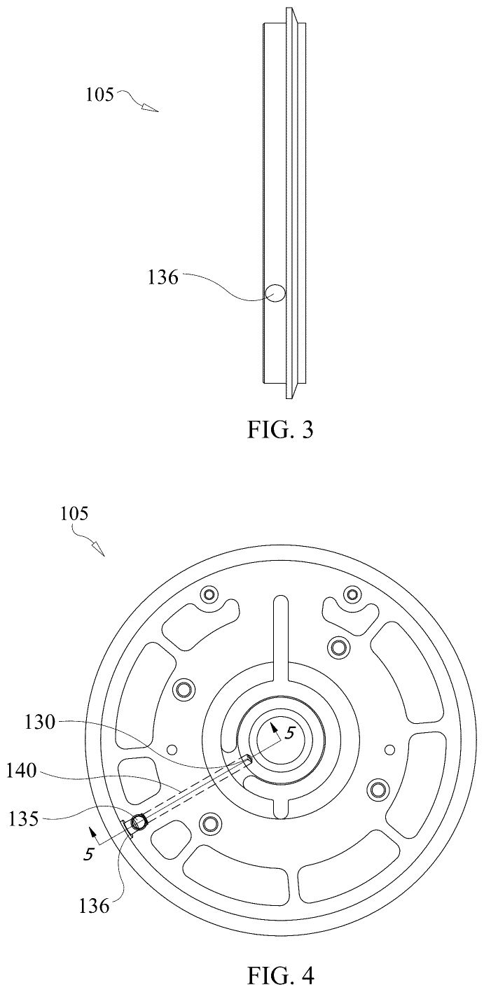

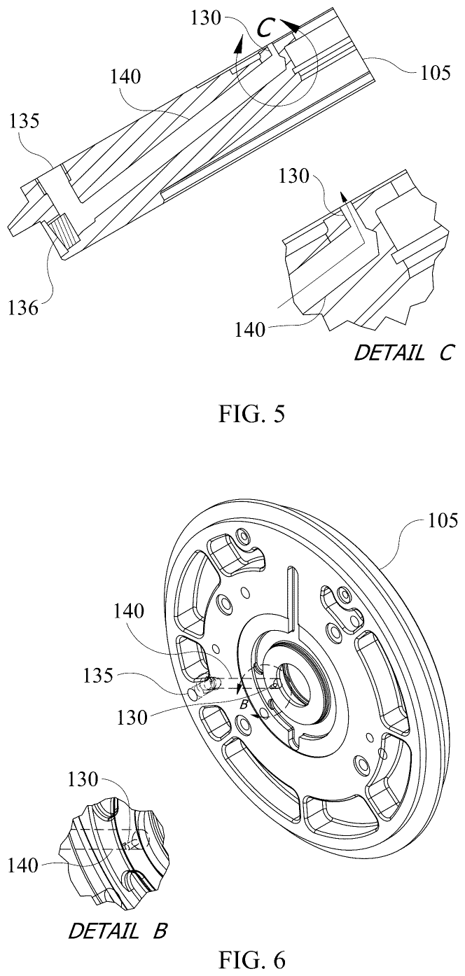

As shown in FIGS. 3 through 6, the backplate 105 of the present invention features an integral oil passage 140 wherein oil is introduced at the inlet 135 located at the proximal end of the oil passage 140, and flows to an oil jet 130 located at the distal end of the oil passage 140, which directs a stream of oil flow from the oil jet 130 to the large bearing 111. This directed flow of oil to the impeller bearing 111 improves heat transfer from the bearing into the oil, thereby reducing the damaging elevated bearing temperatures and as such increases the speed at which the compressor may be operated without overheating the impeller bearing 111. The oil passage 140 is formed in certain embodiments by drilling through the compressor backplate 105 from the outer edge of the backplate 105. A plug 136 is then fitted into the outer portion of the oil passage 140 bore hole to seal the drilled opening at the edge of the compressor backplate 105.

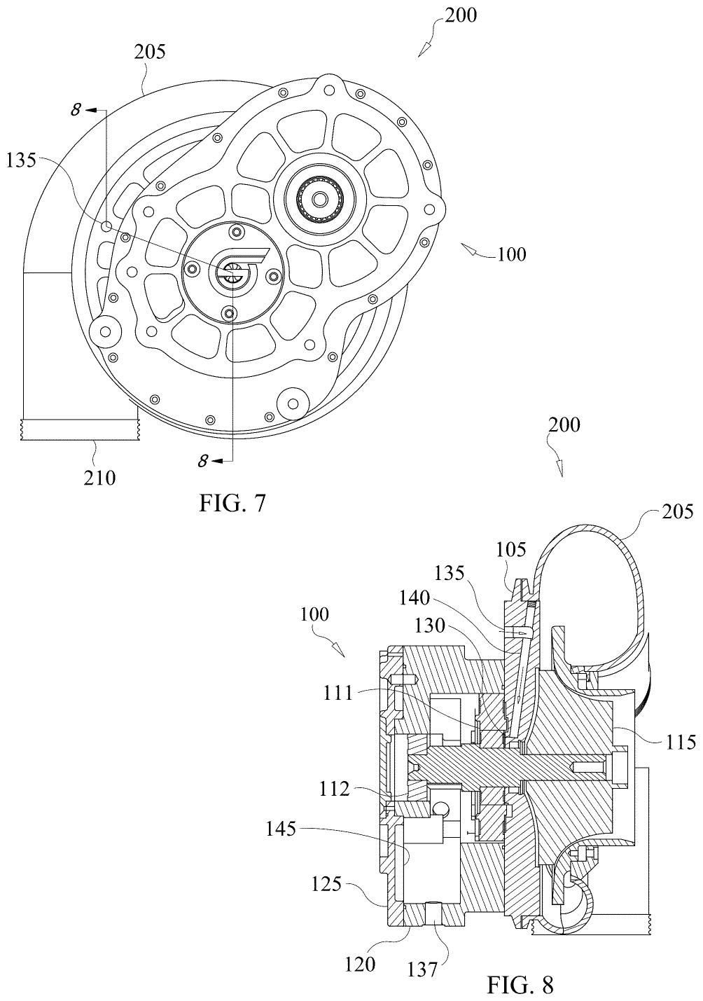

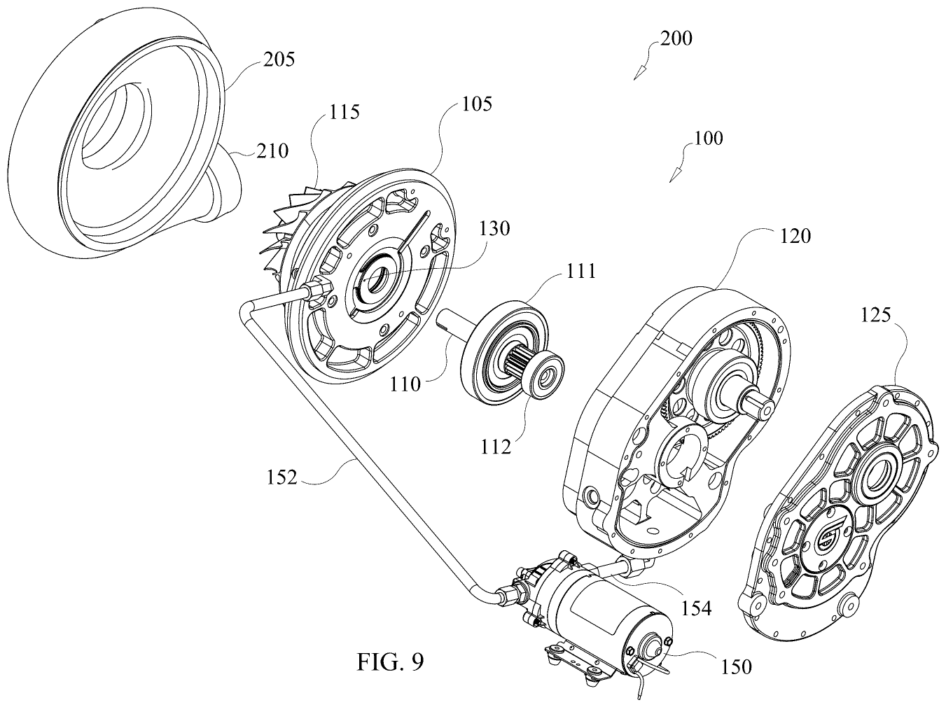

FIGS. 7 and 8 show various views of a supercharger 200 including the backplate 105, transmission case 120 and a compressor housing 205 that fits over and contains the impeller 115. Air drawn through the impeller 115 is compressed within the compressor housing 205 and exits the supercharger 200 through outlet 210. FIG. 8 is a cross-sectional view of a supercharger transmission assembly 100 and supercharger 200. As shown, the transmission case 120 includes an internal oil reservoir 145 and an oil suction aperture 137 in the lower wall of the reservoir 145 through which oil may be drawn from the reservoir 145 by a pump 150 (see FIG. 9) via an oil suction line 154. An oil supply line 152 feeds oil under pressure from the pump 150 to the oil inlet 135 in the compressor backplate 105.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is:

1. A centrifugal supercharger comprising:
a transmission case with an aperture therethrough proximal and parallel to the axis of said transmission case, said transmission case having a front end and a rear end;
a transmission cover affixed to said transmission case rear end;
a compressor backplate affixed to said transmission case front end, said compressor backplate comprising an oil passage radially located within said compressor backplate and having a first opening near the outer edge of thereof at oil inlet and having a second opening near the compressor backplate bore at an oil jet to direct oil upon a proximal bearing;
a distal bearing mounted upon an impeller shaft; and
said proximal bearing mounted upon said impeller shaft and forward of said distal bearing, said distal bearing, proximal bearing and impeller shaft mounted within said aperture of said transmission case.

2. The centrifugal supercharger of claim 1 further comprising a gear type transmission, an internal oil reservoir and oil jet lubrication.

3. The centrifugal supercharger of claim 1 further comprising an oil jet positioned to provide oil jet lubrication of the distal and proximal impeller shaft bearings within said transmission.

4. The centrifugal supercharger of claim 2 wherein said internal oil reservoir is integrated into the transmission case and said oil jet lubrication is integrated into said compressor backplate.

5. The centrifugal supercharger of claim 4 further comprising an oil pump external to said transmission assembly.

6. The centrifugal supercharger of claim 5 comprising an oil suction line attached at one end to an oil suction aperture in the wall of said oil reservoir and at another end to said oil pump.

7. The centrifugal supercharger of claim 5 comprising an oil supply line attached at one end to said oil pump and at another end to said oil inlet in said compressor backplate.

8. The centrifugal supercharger of claim 5 comprising an oil suction line attached at one end to an oil suction aperture in the wall of said oil reservoir and at another end to said pump, and further comprising an oil supply line attached at one end to said oil pump and at another end to said oil inlet, whereby oil may be drawn and flow from said oil suction aperture to said pump and then from said pump to said oil inlet under pressure to eject from said oil jet.

9. The centrifugal supercharger of claim 1 comprising oil jet lubrication of the one or more proximal impeller shaft bearings and splash/bath/mist lubrication of the remaining bearings.

10. A centrifugal supercharger comprising:
a transmission case with an aperture therethrough proximal and parallel to the axis of said transmission case, said transmission case having a front end and a rear end;
a distal bearing mounted upon an impeller shaft and a proximal bearing mounted upon said impeller shaft and forward of said distal bearing, said distal bearing, proximal bearing and impeller shaft mounted within said aperture of said transmission case; and
a compressor backplate affixed to said transmission case front end, said compressor backplate comprising an oil passage radially located within said compressor backplate and having a first opening near the outer edge of thereof at oil inlet and having a second opening near the compressor backplate bore at an oil jet to direct oil upon a proximal bearing.
